(19) United States
(12) Patent Application Publication
(10) Pub. No.: US 2024/0337456 A1
(43) Pub. Date: Oct. 10, 2024

(54) Carbon Firearm Barrel and Related Methods of Manufacturing

(71) Applicant: Grey Birch MFG, Tampa, FL (US)

(72) Inventor: Jeff Hussey, Tampa, FL (US)

(73) Assignee: Grey Birch MFG, Tampa, FL (US)

(21) Appl. No.: 18/628,286

(22) Filed: Apr. 5, 2024

Related U.S. Application Data
(60) Provisional application No. 63/527,240, filed on Jul. 17, 2023.
(60) Provisional application No. 63/457,288, filed on Apr. 5, 2023.

(51) Int. Cl. F41A 21/04; B29D 23/00; B29K 105/08; B29K 307/04; B29K 705/12; F41A 21/48

(52) U.S. Cl. CPC F41A 21/04; B29D 23/001; B29K 2105/0872; B29K 2307/04; B29K 2705/12; F41A 21/48

(57) ABSTRACT

A method of forming a solid-core carbon fiber barrel or carbon fiber gas port barrel for use with a firearm and related kits.

### CROSS REFERENCE TO RELATED APPLICATIONS

This application claims benefit to U.S. Provisional Application No. 63/527,240, filed Jul. 17, 2023, and U.S. Provisional Application No. 63/457,288, filed Apr. 5, 2023. All of the above applications are incorporated herein by reference.

### TECHNICAL FIELD

This disclosure relates to systems and methods of making carbon fiber firearm barrels and barrels for gas actuated firearms.

### BACKGROUND

Firearm barrels have traditional been made of metals and alloys, and in particular, steel. To increase the life of a barrel and the number of rounds that may be fired through the barrel, prior art methods of manufacturing barrels relied upon using increased amounts of steel resulting in a stronger, but heavier barrel.

Barrels with increased weight are generally disfavored. Firearms with heavy barrels become more difficult to transport during hunting and military operations. A barrel with increased strength, longer lifespan, and lighter in weight is desirable.

A barrel formed from a carbon composite and steel may have an extremely reduced weight and greater service life compared to conventional metal and alloy firearm barrels.

### SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

In accordance with one aspect, a method of forming a solid-core carbon fiber firearm barrel may include the steps of winding a dry prepreg carbon fiber around a mandrel to form a carbon tube with a first diameter and the winding may include a vertical angle from 0 to 25 degrees, winding a dry prepreg carbon fiber to form the carbon tube with a second diameter and the winding may include a vertical angle from 30 to 60 degrees, bonding the carbon tube to a steel barrel core with an epoxy, wrapping the carbon tube bonded to the steel core with a compression tape, curing the carbon tube bonded to the steal core, and grinding the carbon tube to a third diameter, and sealing the carbon tube bonded to the steel core.

In some examples, the carbon tube bonded to the steel barrel core may be fed into a grinder having a feed speed of at least 12 inches per 3 minutes. In some examples, the feed speed may be about 10 to 15 inches per 3 minutes. In some examples, the feed blade may be made of brass. In other examples, the brass feed blade may reduce or control vibration in the carbon tube during grinding providing a superior finish. In certain examples, the winding of the first dry prepreg carbon fiber may include a vertical angle from 0 to 10 degrees. In another example, the winding of the second dry prepreg carbon fiber comprises a vertical angle from 30 to 45 degrees. In still other examples, the first diameter may be about 0.400 inches to about 2 inches, the second diameter may be about 0.440 inches to about 3 inches, and the third diameter may be about 0.800 inches to about 3.25 inches.

In accordance with another aspect, a barrel for a firearm may include a steel barrel core, and a carbon fiber tube bonded to an exterior of the steel barrel core. In some examples, the carbon tube may include a first inner diameter comprising dry pre-peg carbon fibers with a wrapped vertical angle from 0 to 25 degrees. In other examples, the carbon tube may include a second outer diameter of dry pre-peg carbon fibers wrapped over the first inner diameter and having a wrapped vertical angle from 30 to 60 degrees. In some examples, the wrapped carbon fibers in the first diameter and second diameter fully extend from one end of the carbon tube to an opposite end of the carbon tube.

In some examples, the first inner diameter may be about 0.400 inches to about 2 inches, the second outer diameter may be about 0.440 inches to about 3 inches, and the finished barrel diameter may be about 0.800 inches to about 3.25 inches. In other examples, the first inner diameter may include dry prepreg carbon fibers having a wrapped vertical angle from 0 to 10 degrees. In still other examples, the second outer diameter comprising dry prepreg carbon fibers positioned over the first inner diameter fibers may include a wrapped vertical angle from 30 to 45 degrees. In certain examples, the barrel may include an end cap threaded on to the barrel core and torqued to at least 40 ft. lbs.

In accordance with other aspects herein, a firearm barrel replacement kit may include a carbon fiber barrel for use with a firearm, and a set of printed safety and/or installation instructions. In some examples, each component is combined into a unitary packaging assembly. In other examples, the replacement carbon fiber barrel may include a steel barrel core, and a carbon fiber tube bonded to an exterior of the steel barrel core. In some examples, the carbon tube may include a first inner diameter comprising dry pre-peg carbon fibers with a wrapped vertical angle from 0 to 25 degrees. In other examples, the carbon tube may include a second outer diameter of dry pre-peg carbon fibers wrapped over the first inner diameter and having a wrapped vertical angle from 30 to 60 degrees. In some examples, the wrapped carbon fibers in the first diameter and second diameter fully extend from one end of the carbon tube to an opposite end of the carbon tube.

In accordance with yet other aspects herein, a gas port barrel for use with a rifle may include a steel barrel core and a carbon tube bonded to an exterior of the steel barrel core. In some examples, the rifle may be an AR-15 type or style of rifle. In yet other examples, the rifle may be an AR-10 type or style of rifle.

In accordance with still other aspects herein, a rifle barrel replacement kit may include a carbon fiber gas port barrel for use with a rifle and a set of printed safety and/or installation instructions. In some examples, each component is combined into a unitary packaging assembly. In other examples, the replacement carbon fiber gas port barrel may include a steel barrel core, and a carbon fiber tube bonded to an exterior of the steel barrel core. In some examples, the rifle may be an AR-15 type or style of rifle. In yet other examples, the rifle may be an AR-10 type or style of rifle.

### BRIEF DESCRIPTION OF THE DRAWINGS

A more complete understanding of the present invention and certain advantages thereof may be acquired by referring to the following detailed description in consideration with the accompanying drawings, in which:

FIG. 1 is a schematic of a carbon tube for a barrel for use in a firearm as disclosed herein.

FIG. 2 is a schematic of a steel barrel for integration with the carbon tube of FIG. 1 and for use in a firearm as disclosed herein.

FIG. 3 is a schematic of a barrel endcap for use in a firearm as disclosed herein.

FIG. 4 is a schematic of an alternative view of the barrel endcap of FIG. 3.

FIG. 5 is a depiction of barrel blank carbon core grind instructions according to the methods disclosed herein.

FIG. 6 includes images of an example barrel core, carbon tube, and barrel endcaps as disclosed herein.

FIGS. 7A and 7B are images of a carbon tube and a carbon tube fused to a barrel core respectively as disclosed herein.

FIG. 8 depicts a firearm barrel replacement kit as disclosed herein.

FIG. 9 depicts an AR-15 type-rifle gas block function schematic.

FIG. 10 depicts a side view of a gas port barrel for a firearm including a first carbon tube around a rifle barrel core, a gas block adapter, and a second carbon tube around the rifle barrel core and secured by an endcap as disclosed herein.

FIG. 11 depicts a schematic of the gas port barrel for a firearm of FIG. 10 as disclosed herein.

FIG. 12 depicts an alternative schematic view of the gas port barrel for a firearm of FIG. 11 as disclosed herein.

### DETAILED DESCRIPTION

The carbon firearm barrel disclosed herein may include a barrel core formed of steel or other metal or alloy, and an outer carbon tube fused or bonded to the barrel core. The carbon tube and barrel core may be referred to herein as a solid-core (meaning zero to minimal space between the carbon tube and the bonded barrel core). The final product, a completed carbon barrel may gain its strength and stiffness primarily via the bonded carbon contacting the exterior steel of the barrel core, and the torsion applied to the carbon tube via the end cap to create increased rigidity in the final barrel assembly. The method of making the carbon barrel, increases the strength, rigidity of the barrel resulting in a firearm barrel with increased service life, increased accuracy, and significant reduction in weight. The carbon fiber barrel may be manufactured with two carbon tube portions affixed to an AR-15 style barrel core and on each side of a gas block adapter affixed to the AR-15 style barrel core.

To achieve the advantages provided by a solid-core carbon fiber barrel without requiring a carbon tube made by high wind angles, the carbon tube may be wound on a mandrel and subsequently transferred and bonded to a barrel core. The carbon tube may be wound on a mandrel with a length greater than the barrel core length. This allows the carbon core to be sectioned or cut into smaller lengths, allowing for the carbon fiber to be wound fully at the desired wind angle from one end of the barrel to the other. In conventional winding methods, the wind angle cannot be maintained to the extreme ends of the barrel core due to physical constraints of winding directly on a barrel core.

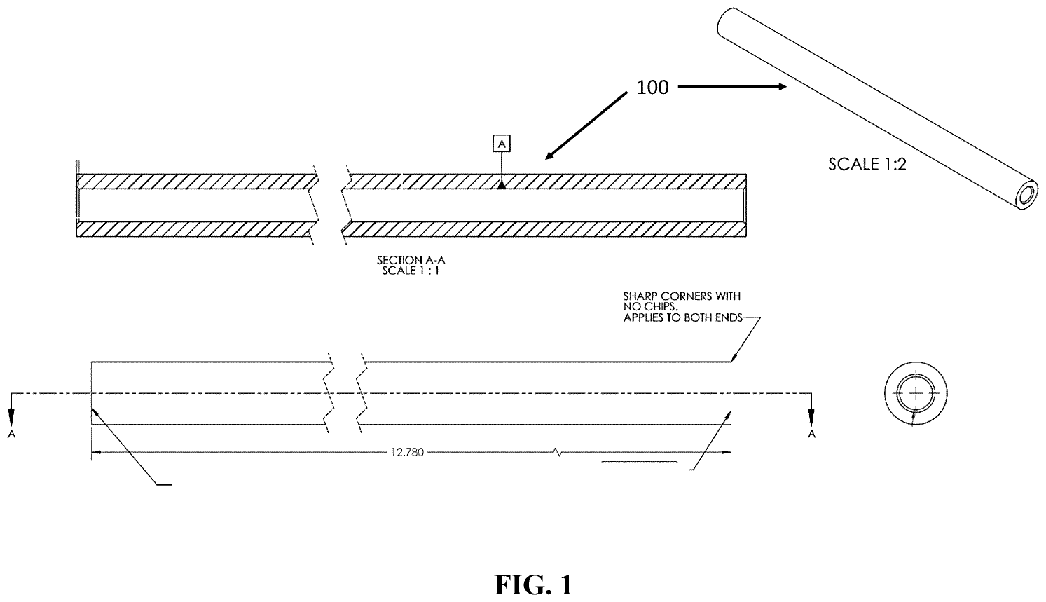

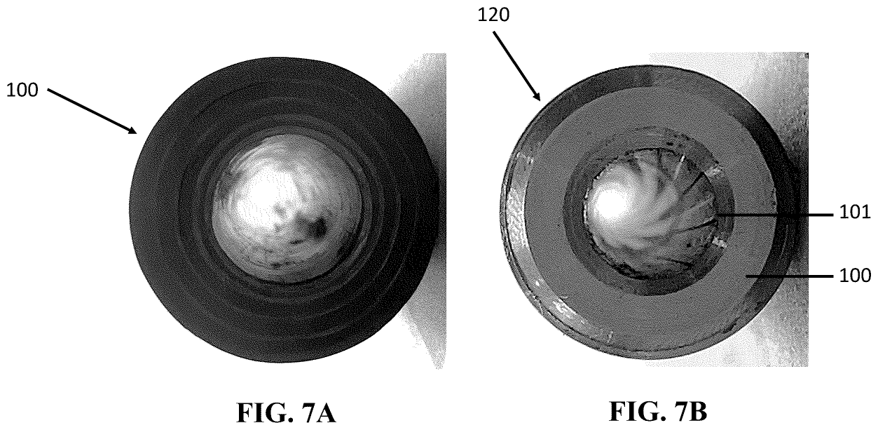

As shown in FIGS. 1 and 7A, carbon tube 100 may be formed by wrapping a dry prepreg carbon fiber about a mandrel to a desired diameter. In other examples, a wet prepreg carbon fiber may be used. In some examples, combinations of wet and dry prepreg fibers may be used. The desired diameter may be achieved by wrapping the carbon fiber using a wind angle from about 0 degrees to about 25 degrees. According to another aspect, vertical wind angles used to create an inner diameter of the carbon tube as disclosed herein may be, for example, at least, greater than, less than, equal to, or any number in between about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, and 60 degrees. In some aspects, the first or inner diameter of the carbon tube after wrapping may be for example, at least, greater than, less than, equal to, or any number in between about 0.400, 0.401, 0.402, 0.403, 0.404, 0.405, 0.406, 0.407, 0.408, 0.409, 0.410, 0.411, 0.412, 0.413, 0.414, 0.415, 0.416, 0.417, 0.418, 0.419, 0.420, 0.421, 0.422, 0.423, 0.424, 0.425, 0.426, 0.427, 0.428, 0.429, 0.430, 0.431, 0.432, 0.433, 0.434, 0.435, 0.436, 0.437, 0.438, 0.439, 0.440, 0.441, 0.442, 0.443, 0.444, 0.445, 0.446, 0.447, 0.448, 0.449, 0.450, 0.451, 0.452, 0.453, 0.454, 0.455, 0.456, 0.457, 0.458, 0.459, 0.460, 0.461, 0.462, 0.463, 0.464, 0.465, 0.466, 0.467, 0.468, 0.469, 0.470, 0.471, 0.472, 0.473, 0.474, 0.475, 0.476, 0.477, 0.478, 0.479, 0.480, 0.481, 0.482, 0.483, 0.484, 0.485, 0.486, 0.487, 0.488, 0.489, 0.490, 0.491, 0.492, 0.493, 0.494, 0.495, 0.496, 0.497, 0.498, 0.499, 0.500, 0.501, 0.502, 0.503, 0.504, 0.505, 0.506, 0.507, 0.508, 0.509, 0.510, 0.511, 0.512, 0.513, 0.514, 0.515, 0.516, 0.517, 0.518, 0.519, 0.52, 0.521, 0.522, 0.523, 0.524, 0.525, 0.526, 0.527, 0.528, 0.529, 0.53, 0.531, 0.532, 0.533, 0.534, 0.535, 0.536, 0.537, 0.538, 0.539, 0.54, 0.541, 0.542, 0.543, 0.544, 0.545, 0.546, 0.547, 0.548, 0.549, 0.55, 0.551, 0.552, 0.553, 0.554, 0.555, 0.556, 0.557, 0.558, 0.559, 0.56, 0.561, 0.562, 0.563, 0.564, 0.565, 0.566, 0.567, 0.568, 0.569, 0.57, 0.571, 0.572, 0.573, 0.574, 0.575, 0.576, 0.577, 0.578, 0.579, 0.58, 0.581, 0.582, 0.583, 0.584, 0.585, 0.586, 0.587, 0.588, 0.589, 0.59, 0.591, 0.592, 0.593, 0.594, 0.595, 0.596, 0.597, 0.598, 0.599, 0.6, 0.601, 0.602, 0.603, 0.604, 0.605, 0.606, 0.607, 0.608, 0.609, 0.61, 0.611, 0.612, 0.613, 0.614, 0.615, 0.616, 0.617, 0.618, 0.619, 0.62, 0.621, 0.622, 0.623, 0.624, 0.625, 0.626, 0.627, 0.628, 0.629, 0.63, 0.631, 0.632, 0.633, 0.634, 0.635, 0.636, 0.637, 0.638, 0.639, 0.64, 0.641, 0.642, 0.643, 0.644, 0.645, 0.646, 0.647, 0.648, 0.649, 0.65, 0.651, 0.652, 0.653, 0.654, 0.655, 0.656, 0.657, 0.658, 0.659, 0.66, 0.661, 0.662, 0.663, 0.664, 0.665, 0.666, 0.667, 0.668, 0.669, 0.67, 0.671, 0.672, 0.673, 0.674, 0.675, 0.676, 0.677, 0.678, 0.679, 0.68, 0.681, 0.682, 0.683, 0.684, 0.685, 0.686, 0.687, 0.688, 0.689, 0.69, 0.691, 0.692, 0.693, 0.694, 0.695, 0.696, 0.697, 0.698, 0.699, 0.7, 0.701, 0.702, 0.703, 0.704, 0.705, 0.706, 0.707, 0.708, 0.709, 0.71, 0.711, 0.712, 0.713, 0.714, 0.715, 0.716, 0.717, 0.718, 0.719, 0.72, 0.721, 0.722, 0.723, 0.724, 0.725, 0.726, 0.727, 0.728, 0.729, 0.73, 0.731, 0.732, 0.733, 0.734, 0.735, 0.736, 0.737, 0.738, 0.739, 0.74, 0.741, 0.742, 0.743, 0.744, 0.745, 0.746, 0.747, 0.748, 0.749, 0.75, 0.751, 0.752, 0.753, 0.754, 0.755, 0.756, 0.757, 0.758, 0.759, 0.76, 0.761, 0.762, 0.763, 0.764, 0.765, 0.766, 0.767, 0.768, 0.769, 0.77, 0.771, 0.772, 0.773, 0.774, 0.775, 0.776, 0.777, 0.778, 0.779, 0.78, 0.781, 0.782, 0.783, 0.784, 0.785, 0.786, 0.787, 0.788, 0.789, 0.79, 0.791, 0.792, 0.793, 0.794, 0.795, 0.796, 0.797, 0.798, 0.799, 0.8, 0.801, 0.802, 0.803, 0.804, 0.805, 0.806, 0.807, 0.808, 0.809, 0.81, 0.811, 0.812, 0.813, 0.814, 0.815, 0.816, 0.817, 0.818, 0.819, 0.82, 0.821, 0.822, 0.823, 0.824, 0.825, 0.826, 0.827, 0.828, 0.829, 0.83, 0.831, 0.832, 0.833, 0.834, 0.835, 0.836, 0.837, 0.838, 0.839, 0.84, 0.841, 0.842, 0.843, 0.844, 0.845, 0.846, 0.847, 0.848, 0.849, 0.85, 0.851, 0.852, 0.853, 0.854, 0.855, 0.856, 0.857, 0.858, 0.859, 0.86, 0.861, 0.862, 0.863, 0.864, 0.865, 0.866, 0.867, 0.868, 0.869, 0.87, 0.871, 0.872, 0.873, 0.874, 0.875, 0.876, 0.877, 0.878, 0.879, 0.88, 0.881, 0.882, 0.883, 0.884, 0.885, 0.886, 0.887, 0.888, 0.889, and 0.890, inches.

As also depicted in FIGS. 1 and 7A, carbon tube 100 may be formed by wrapping a second dry prepreg carbon fiber over the first carbon tube layer or inner diameter using a mandrel to a desired second or outer diameter. In other examples, a wet prepreg carbon fiber may be used. In some examples, combinations of wet and dry prepreg fibers may be used. The desired outer diameter may be achieved by wrapping the carbon fiber using a wind angle from about 30 degrees to about 60 degrees. According to another aspect, vertical wind angles used to create an outer or second diameter of the carbon tube as disclosed herein may be, for example, at least, greater than, less than, equal to, or any number in between about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, and 90 degrees. In some aspects, the second or outer diameter of the completed carbon tube after wrapping may be for example, at least, greater than, less than, equal to, or any number in between about 0.400, 0.401, 0.402, 0.403, 0.404, 0.405, 0.406, 0.407, 0.408, 0.409, 0.410, 0.411, 0.412, 0.413, 0.414, 0.415, 0.416, 0.417, 0.418, 0.419, 0.420, 0.421, 0.422, 0.423, 0.424, 0.425, 0.426, 0.427, 0.428, 0.429, 0.430, 0.431, 0.432, 0.433, 0.434, 0.435, 0.436, 0.437, 0.438, 0.439, 0.440, 0.441, 0.442, 0.443, 0.444, 0.445, 0.446, 0.447, 0.448, 0.449, 0.450, 0.451, 0.452, 0.453, 0.454, 0.455, 0.456, 0.457, 0.458, 0.459, 0.460, 0.461, 0.462, 0.463, 0.464, 0.465, 0.466, 0.467, 0.468, 0.469, 0.470, 0.471, 0.472, 0.473, 0.474, 0.475, 0.476, 0.477, 0.478, 0.479, 0.480, 0.481, 0.482, 0.483, 0.484, 0.485, 0.486, 0.487, 0.488, 0.489, 0.490, 0.491, 0.492, 0.493, 0.494, 0.495, 0.496, 0.497, 0.498, 0.499, 0.500, 0.501, 0.502, 0.503, 0.504, 0.505, 0.506, 0.507, 0.508, 0.509, 0.510, 0.511, 0.512, 0.513, 0.514, 0.515, 0.516, 0.517, 0.518, 0.519, 0.52, 0.521, 0.522, 0.523, 0.524, 0.525, 0.526, 0.527, 0.528, 0.529, 0.53, 0.531, 0.532, 0.533, 0.534, 0.535, 0.536, 0.537, 0.538, 0.539, 0.54, 0.541, 0.542, 0.543, 0.544, 0.545, 0.546, 0.547, 0.548, 0.549, 0.55, 0.551, 0.552, 0.553, 0.554, 0.555, 0.556, 0.557, 0.558, 0.559, 0.56, 0.561, 0.562, 0.563, 0.564, 0.565, 0.566, 0.567, 0.568, 0.569, 0.57, 0.571, 0.572, 0.573, 0.574, 0.575, 0.576, 0.577, 0.578, 0.579, 0.58, 0.581, 0.582, 0.583, 0.584, 0.585, 0.586, 0.587, 0.588, 0.589, 0.59, 0.591, 0.592, 0.593, 0.594, 0.595, 0.596, 0.597, 0.598, 0.599, 0.6, 0.601, 0.602, 0.603, 0.604, 0.605, 0.606, 0.607, 0.608, 0.609, 0.61, 0.611, 0.612, 0.613, 0.614, 0.615, 0.616, 0.617, 0.618, 0.619, 0.62, 0.621, 0.622, 0.623, 0.624, 0.625, 0.626, 0.627, 0.628, 0.629, 0.63, 0.631, 0.632, 0.633, 0.634, 0.635, 0.636, 0.637, 0.638, 0.639, 0.64, 0.641, 0.642, 0.643, 0.644, 0.645, 0.646, 0.647, 0.648, 0.649, 0.65, 0.651, 0.652, 0.653, 0.654, 0.655, 0.656, 0.657, 0.658, 0.659, 0.66, 0.661, 0.662, 0.663, 0.664, 0.665, 0.666, 0.667, 0.668, 0.669, 0.67, 0.671, 0.672, 0.673, 0.674, 0.675, 0.676, 0.677, 0.678, 0.679, 0.68, 0.681, 0.682, 0.683, 0.684, 0.685, 0.686, 0.687, 0.688, 0.689, 0.69, 0.691, 0.692, 0.693, 0.694, 0.695, 0.696, 0.697, 0.698, 0.699, 0.7, 0.701, 0.702, 0.703, 0.704, 0.705, 0.706, 0.707, 0.708, 0.709, 0.71, 0.711, 0.712, 0.713, 0.714, 0.715, 0.716, 0.717, 0.718, 0.719, 0.72, 0.721, 0.722, 0.723, 0.724, 0.725, 0.726, 0.727, 0.728, 0.729, 0.73, 0.731, 0.732, 0.733, 0.734, 0.735, 0.736, 0.737, 0.738, 0.739, 0.74, 0.741, 0.742, 0.743, 0.744, 0.745, 0.746, 0.747, 0.748, 0.749, 0.75, 0.751, 0.752, 0.753, 0.754, 0.755, 0.756, 0.757, 0.758, 0.759, 0.76, 0.761, 0.762, 0.763, 0.764, 0.765, 0.766, 0.767, 0.768, 0.769, 0.77, 0.771, 0.772, 0.773, 0.774, 0.775, 0.776, 0.777, 0.778, 0.779, 0.78, 0.781, 0.782, 0.783, 0.784, 0.785, 0.786, 0.787, 0.788, 0.789, 0.79, 0.791, 0.792, 0.793, 0.794, 0.795, 0.796, 0.797, 0.798, 0.799, 0.8, 0.801, 0.802, 0.803, 0.804, 0.805, 0.806, 0.807, 0.808, 0.809, 0.81, 0.811, 0.812, 0.813, 0.814, 0.815, 0.816, 0.817, 0.818, 0.819, 0.82, 0.821, 0.822, 0.823, 0.824, 0.825, 0.826, 0.827, 0.828, 0.829, 0.83, 0.831, 0.832, 0.833, 0.834, 0.835, 0.836, 0.837, 0.838, 0.839, 0.84, 0.841, 0.842, 0.843, 0.844, 0.845, 0.846, 0.847, 0.848, 0.849, 0.85, 0.851, 0.852, 0.853, 0.854, 0.855, 0.856, 0.857, 0.858, 0.859, 0.86, 0.861, 0.862, 0.863, 0.864, 0.865, 0.866, 0.867, 0.868, 0.869, 0.87, 0.871, 0.872, 0.873, 0.874, 0.875, 0.876, 0.877, 0.878, 0.879, 0.88, 0.881, 0.882, 0.883, 0.884, 0.885, 0.886, 0.887, 0.888, 0.889, 0.890, 0.891, 0.892, 0.893, 0.894, 0.895, 0.896, 0.897, 0.898, 0.899, 0.900, 0.901, 0.902, 0.903, 0.904, 0.905, 0.906, 0.907, 0.908, 0.909, 0.910, 0.911, 0.912, 0.913, 0.914, 0.915, 0.916, 0.917, 0.918, 0.919, 0.920, 0.921, 0.922, 0.923, 0.924, 0.925, 0.926, 0.927, 0.928, 0.929, 0.93, 0.931, 0.932, 0.933, 0.934, 0.935, 0.936, 0.937, 0.938, 0.939, 0.940, 0.941, 0.942, 0.943, 0.944, 0.945, 0.946, 0.947, 0.948, 0.949, 0.950, 0.951, 0.952, 0.953, 0.954, 0.955, 0.956, 0.957, 0.958, 0.959, 0.960, 0.961, 0.962, 0.963, 0.964, 0.965, 0.966, 0.967, 0.968, 0.969, 0.97, 0.971, 0.972, 0.973, 0.974, 0.975, 0.976, 0.977, 0.978, 0.979, 0.980, 0.981, 0.982, 0.983, 0.984, 0.985, 0.986, 0.987, 0.988, 0.989, 0.990, 0.991, 0.992, 0.993, 0.994, 0.995, 0.996, 0.997, 0.998, and 0.999 inches.

In still other aspects the first inner diameter, the second outer diameter, and/or a third or finished product diameter may be for example, at least, greater than, less than, equal to, or any number in between about 0.400, 0.401, 0.402, 0.403, 0.404, 0.405, 0.406, 0.407, 0.408, 0.409, 0.410, 0.411, 0.412, 0.413, 0.414, 0.415, 0.416, 0.417, 0.418, 0.419, 0.420, 0.421, 0.422, 0.423, 0.424, 0.425, 0.426, 0.427, 0.428, 0.429, 0.430, 0.431, 0.432, 0.433, 0.434, 0.435, 0.436, 0.437, 0.438, 0.439, 0.440, 0.441, 0.442, 0.443, 0.444, 0.445, 0.446, 0.447, 0.448, 0.449, 0.450, 0.451, 0.452, 0.453, 0.454, 0.455, 0.456, 0.457, 0.458, 0.459, 0.460, 0.461, 0.462, 0.463, 0.464, 0.465, 0.466, 0.467, 0.468, 0.469, 0.470, 0.471, 0.472, 0.473, 0.474, 0.475, 0.476, 0.477, 0.478, 0.479, 0.480, 0.481, 0.482, 0.483, 0.484, 0.485, 0.486, 0.487, 0.488, 0.489, 0.490, 0.491, 0.492, 0.493, 0.494, 0.495, 0.496, 0.497, 0.498, 0.499, 0.500, 0.501, 0.502, 0.503, 0.504, 0.505, 0.506, 0.507, 0.508, 0.509, 0.510, 0.511, 0.512, 0.513, 0.514, 0.515, 0.516, 0.517, 0.518, 0.519, 0.52, 0.521, 0.522, 0.523, 0.524, 0.525, 0.526, 0.527, 0.528, 0.529, 0.53, 0.531, 0.532, 0.533, 0.534, 0.535, 0.536, 0.537, 0.538, 0.539, 0.54, 0.541, 0.542, 0.543, 0.544, 0.545, 0.546, 0.547, 0.548, 0.549, 0.55, 0.551, 0.552, 0.553, 0.554, 0.555, 0.556, 0.557, 0.558, 0.559, 0.56, 0.561, 0.562, 0.563, 0.564, 0.565, 0.566, 0.567, 0.568, 0.569, 0.57, 0.571, 0.572, 0.573, 0.574, 0.575, 0.576, 0.577, 0.578, 0.579, 0.58, 0.581, 0.582, 0.583, 0.584, 0.585, 0.586, 0.587, 0.588, 0.589, 0.59, 0.591, 0.592, 0.593, 0.594, 0.595, 0.596, 0.597, 0.598, 0.599, 0.6, 0.601, 0.602, 0.603, 0.604, 0.605, 0.606, 0.607, 0.608, 0.609, 0.61, 0.611, 0.612, 0.613, 0.614, 0.615, 0.616, 0.617, 0.618, 0.619, 0.62, 0.621, 0.622, 0.623, 0.624, 0.625, 0.626, 0.627, 0.628, 0.629, 0.63, 0.631, 0.632, 0.633, 0.634, 0.635, 0.636, 0.637, 0.638, 0.639, 0.64, 0.641, 0.642, 0.643, 0.644, 0.645, 0.646, 0.647, 0.648, 0.649, 0.65, 0.651, 0.652, 0.653, 0.654, 0.655, 0.656, 0.657, 0.658, 0.659, 0.66, 0.661, 0.662, 0.663, 0.664, 0.665, 0.666, 0.667, 0.668, 0.669, 0.67, 0.671, 0.672, 0.673, 0.674, 0.675, 0.676, 0.677, 0.678, 0.679, 0.68, 0.681, 0.682, 0.683, 0.684, 0.685, 0.686, 0.687, 0.688, 0.689, 0.69, 0.691, 0.692, 0.693, 0.694, 0.695, 0.696, 0.697, 0.698, 0.699, 0.7, 0.701, 0.702, 0.703, 0.704, 0.705, 0.706, 0.707, 0.708, 0.709, 0.71, 0.711, 0.712, 0.713, 0.714, 0.715, 0.716, 0.717, 0.718, 0.719, 0.72, 0.721, 0.722, 0.723, 0.724, 0.725, 0.726, 0.727, 0.728, 0.729, 0.73, 0.731, 0.732, 0.733, 0.734, 0.735, 0.736, 0.737, 0.738, 0.739, 0.74, 0.741, 0.742, 0.743, 0.744, 0.745, 0.746, 0.747, 0.748, 0.749, 0.75, 0.751, 0.752, 0.753, 0.754, 0.755, 0.756, 0.757, 0.758, 0.759, 0.76, 0.761, 0.762, 0.763, 0.764, 0.765, 0.766, 0.767, 0.768, 0.769, 0.77, 0.771, 0.772, 0.773, 0.774, 0.775, 0.776, 0.777, 0.778, 0.779, 0.78, 0.781, 0.782, 0.783, 0.784, 0.785, 0.786, 0.787, 0.788, 0.789, 0.79, 0.791, 0.792, 0.793, 0.794, 0.795, 0.796, 0.797, 0.798, 0.799, 0.8, 0.801, 0.802, 0.803, 0.804, 0.805, 0.806, 0.807, 0.808, 0.809, 0.81, 0.811, 0.812, 0.813, 0.814, 0.815, 0.816, 0.817, 0.818, 0.819, 0.82, 0.821, 0.822, 0.823, 0.824, 0.825, 0.826, 0.827, 0.828, 0.829, 0.83, 0.831, 0.832, 0.833, 0.834, 0.835, 0.836, 0.837, 0.838, 0.839, 0.84, 0.841, 0.842, 0.843, 0.844, 0.845, 0.846, 0.847, 0.848, 0.849, 0.85, 0.851, 0.852, 0.853, 0.854, 0.855, 0.856, 0.857, 0.858, 0.859, 0.86, 0.861, 0.862, 0.863, 0.864, 0.865, 0.866, 0.867, 0.868, 0.869, 0.87, 0.871, 0.872, 0.873, 0.874, 0.875, 0.876, 0.877, 0.878, 0.879, 0.88, 0.881, 0.882, 0.883, 0.884, 0.885, 0.886, 0.887, 0.888, 0.889, and 0.890, inches 0.890, 0.891, 0.892, 0.893, 0.894, 0.895, 0.896, 0.897, 0.898, 0.899, 0.900, 0.901, 0.902, 0.903, 0.904, 0.905, 0.906, 0.907, 0.908, 0.909, 0.910, 0.911, 0.912, 0.913, 0.914, 0.915, 0.916, 0.917, 0.918, 0.919, 0.920, 0.921, 0.922, 0.923, 0.924, 0.925, 0.926, 0.927, 0.928, 0.929, 0.93, 0.931, 0.932, 0.933, 0.934, 0.935, 0.936, 0.937, 0.938, 0.939, 0.940, 0.941, 0.942, 0.943, 0.944, 0.945, 0.946, 0.947, 0.948, 0.949, 0.950, 0.951, 0.952, 0.953, 0.954, 0.955, 0.956, 0.957, 0.958, 0.959, 0.960, 0.961, 0.962, 0.963, 0.964, 0.965, 0.966, 0.967, 0.968, 0.969, 0.97, 0.971, 0.972, 0.973, 0.974, 0.975, 0.976, 0.977, 0.978, 0.979, 0.980, 0.981, 0.982, 0.983, 0.984, 0.985, 0.986, 0.987, 0.988, 0.989, 0.990, 0.991, 0.992, 0.993, 0.994, 0.995, 0.996, 0.997, 0.998, 0.999, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, 1.44, 1.45, 1.46, 1.47, 1.48, 1.49, 1.50, 1.51, 1.52, 1.53, 1.54, 1.55, 1.56, 1.57, 1.58, 1.59, 1.60, 1.61, 1.62, 1.63, 1.64, 1.65, 1.66, 1.67, 1.68, 1.69, 1.70, 1.71, 1.72, 1.73, 1.74, 1.75, 1.76, 1.77, 1.78, 1.79, 1.80, 1.81, 1.82, 1.83, 1.84, 1.85, 1.86, 1.87, 1.88, 1.89, 1.90, 1.91, 1.92, 1.93, 1.94, 1.95, 1.96, 1.97, 1.98, 1.99, 2.00, 2.01, 2.02, 2.03, 2.04, 2.05, 2.06, 2.07, 2.08, 2.09, 2.10, 2.11, 2.12, 2.13, 2.14, 2.15, 2.16, 2.17, 2.18, 2.19, 2.20, 2.21, 2.22, 2.23, 2.24, 2.25, 2.26, 2.27, 2.28, 2.29, 2.30, 2.31, 2.32, 2.33, 2.34, 2.35, 2.36, 2.37, 2.38, 2.39, 2.40, 2.41, 2.42, 2.43, 2.44, 2.45, 2.46, 2.47, 2.48, 2.49, 2.50, 2.51, 2.52, 2.53, 2.54, 2.55, 2.56, 2.57, 2.58, 2.59, 2.60, 2.61, 2.62, 2.63, 2.64, 2.65, 2.66, 2.67, 2.68, 2.69, 2.70, 2.71, 2.72, 2.73, 2.74, 2.75, 2.76, 2.77, 2.78, 2.79, 2.80, 2.81, 2.82, 2.83, 2.84, 2.85, 2.86, 2.87, 2.88, 2.89, 2.90, 2.91, 2.92, 2.93, 2.94, 2.95, 2.96, 2.97, 2.98, 2.99, 3.00, 3.01, 3.02, 3.03, 3.04, 3.05, 3.06, 3.07, 3.08, 3.09, 3.10, 3.11, 3.12, 3.13, 3.14, 3.15, 3.16, 3.17, 3.18, 3.19, 3.20, 3.21, 3.22, 3.23, 3.24, and 3.25 inches

As disclosed herein, winding the prepreg carbon fibers at near vertical angles significantly increases horizontal rigidity, stiffness, and aesthetic appearance compared to traditional and prior art vertical angle winding techniques. Use of a dry prepreg is also a superior technique providing surprising results and improvements over prior art and conventional firearm barrels. According to one aspect, computer numerical control machines and related tensioners may apply constant and consistent pressure throughout the winding to achieve the wind angles disclosed herein. As previously discussed, the carbon tube may be wound on a mandrel with a length greater than the barrel core length. This allows the carbon core to be sectioned or cut into smaller lengths, allowing for the carbon fiber to be wound fully at the desired wind angle from one end of the barrel to the other and ultimately extending fully from one end of the barrel core to the opposite end.

After the wrapping of carbon fiber to form the carbon tube 100 is complete, the tube may be heated until cured in an autoclave or other oven as known in the art. In some examples, the carbon tube 100 may be wrapped with a compression tape prior to heating to hold the carbon fibers in place until the resin cures. The completed carbon tube 100 may then be removed from the mandrel.

In another example, a solid core carbon tube may be machined to wrap or affix directly to a steel barrel core. In some examples, the carbon tube may be affixed to the barrel core with a resin or epoxy. In some examples, the barrel core may be treated prior to applying or affixing the carbon tube to the barrel core. The barrel core may be treated with a chrome lining, nitride, DLC, or combinations thereof to greatly enhance the final carbon fiber barrel. In some examples, the steel barrel core may be treated and the carbon tube may then be bonded or mounted to the barrel core. The carbon tube may then be sent for grinding and finishing.

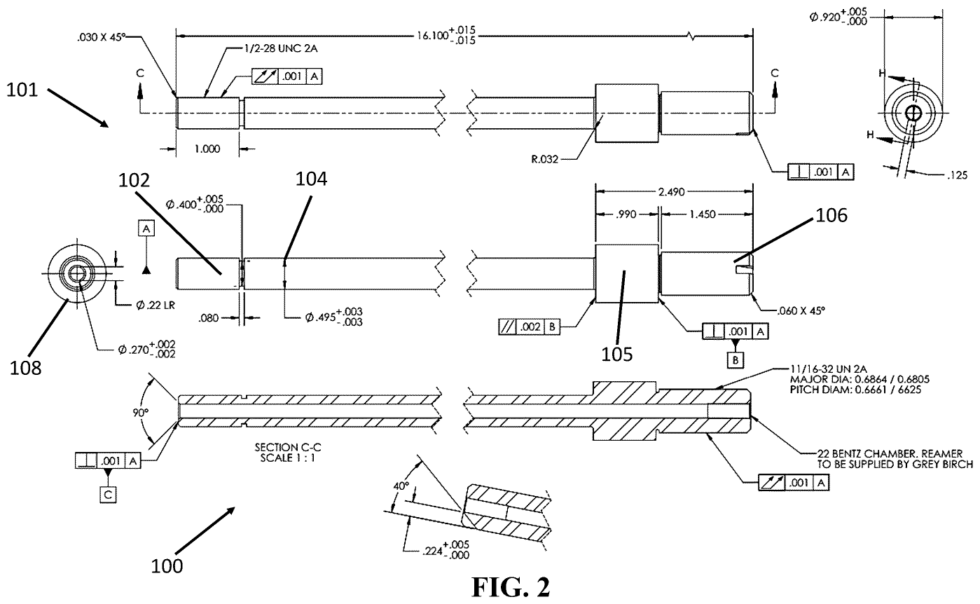

As shown in FIG. 2 and FIG. 7B, barrel core 101 may be any steel. In some examples, barrel core 101 may be steel, other metal, alloy, or combinations thereof. Barrel diameter 104 and the outer barrel core surface that the carbon is to be bonded to may be, for example, at least, greater than, less than, equal to, or any number in between about 0.250, 0.251, 0.252, 0.253, 0.254, 0.255, 0.256, 0.257, 0.258, 0.259, 0.260, 0.261, 0.262, 0.263, 0.264, 0.265, 0.266, 0.267, 0.268, 0.269, 0.270, 0.271, 0.272, 0.273, 0.274, 0.275, 0.276, 0.277, 0.278, 0.279, 0.280, 0.281, 0.282, 0.283, 0.284, 0.285, 0.286, 0.287, 0.288, 0.289, 0.29, 0.291, 0.292, 0.293, 0.294, 0.295, 0.296, 0.297, 0.298, 0.299, 0.3, 0.301, 0.302, 0.303, 0.304, 0.305, 0.306, 0.307, 0.308, 0.309, 0.31, 0.311, 0.312, 0.313, 0.314, 0.315, 0.316, 0.317, 0.318, 0.319, 0.32, 0.321, 0.322, 0.323, 0.324, 0.325, 0.326, 0.327, 0.328, 0.329, 0.33, 0.331, 0.332, 0.333, 0.334, 0.335, 0.336, 0.337, 0.338, 0.339, 0.34, 0.341, 0.342, 0.343, 0.344, 0.345, 0.346, 0.347, 0.348, 0.349, 0.35, 0.351, 0.352, 0.353, 0.354, 0.355, 0.356, 0.357, 0.358, 0.359, 0.36, 0.361, 0.362, 0.363, 0.364, 0.365, 0.366, 0.367, 0.368, 0.369, 0.37, 0.371, 0.372, 0.373, 0.374, 0.375, 0.376, 0.377, 0.378, 0.379, 0.38, 0.381, 0.382, 0.383, 0.384, 0.385, 0.386, 0.387, 0.388, 0.389, 0.39, 0.391, 0.392, 0.393, 0.394, 0.395, 0.396, 0.397, 0.398, 0.399, 0.4, 0.401, 0.402, 0.403, 0.404, 0.405, 0.406, 0.407, 0.408, 0.409, 0.41, 0.411, 0.412, 0.413, 0.414, 0.415, 0.416, 0.417, 0.418, 0.419, 0.42, 0.421, 0.422, 0.423, 0.424, 0.425, 0.426, 0.427, 0.428, 0.429, 0.43, 0.431, 0.432, 0.433, 0.434, 0.435, 0.436, 0.437, 0.438, 0.439, 0.44, 0.441, 0.442, 0.443, 0.444, 0.445, 0.446, 0.447, 0.448, 0.449, 0.45, 0.451, 0.452, 0.453, 0.454, 0.455, 0.456, 0.457, 0.458, 0.459, 0.46, 0.461, 0.462, 0.463, 0.464, 0.465, 0.466, 0.467, 0.468, 0.469, 0.47, 0.471, 0.472, 0.473, 0.474, 0.475, 0.476, 0.477, 0.478, 0.479, 0.48, 0.481, 0.482, 0.483, 0.484, 0.485, 0.486, 0.487, 0.488, 0.489, 0.49, 0.491, 0.492, 0.493, 0.494, 0.495, 0.496, 0.497, 0.498, and 0.499 inches.

As also shown in FIG. 2, barrel core 101 may also include barrel ends 102 and 106. A surface finish barrel core 101 may be between 1.6-3.2 RA, a level of roughness to assist with the bonding of the carbon tube 100 to barrel core 101. Carbon tube 100 may be bonded to barrel core 101 via an epoxy, resin, or other adhesive known in the art. Barrel end 102 may be threaded to allow for end cap 108/110 to be threaded on to barrel core 101 to retain, tension, and cap the carbon fiber tube 100. As noted above, when a finished carbon tube is removed from a mandrel after winding, the carbon tube 100 may be cut in sections allowing the desired winding to extend from threaded barrel core end 102 to end 105 opposite end of barrel core 105.

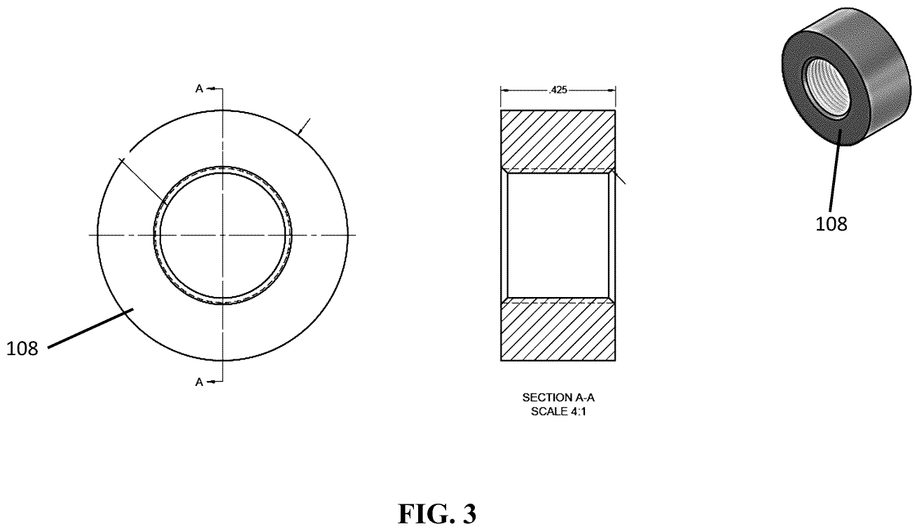

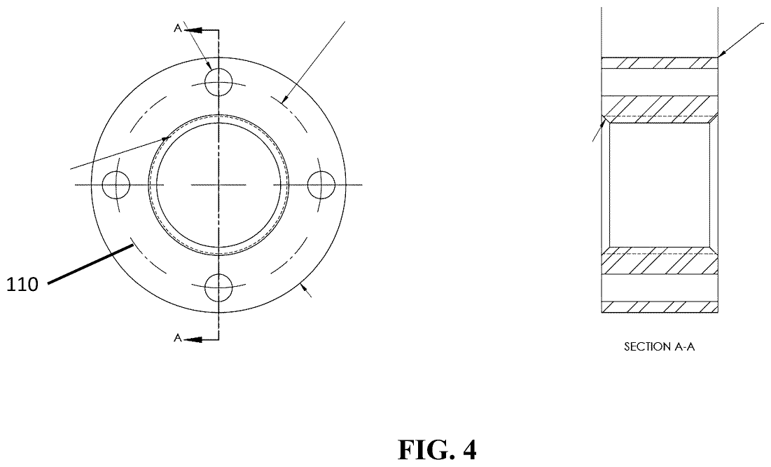

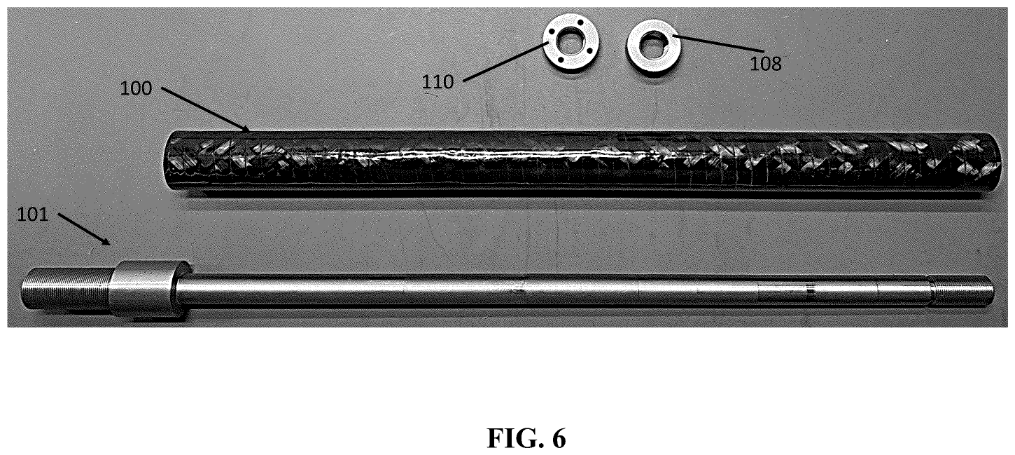

As shown in FIGS. 3 and 4, end caps 108 and 110 may be any type of steel with any type of finish. In some examples, the end caps 108 and 110 may comprise steel, other metal, alloys, or combinations thereof. As shown in FIG. 4 and FIG. 6, end cap 110 may include at least 2, 3, 4, 5, 6, 7, 8, 9, or 10 ports in the face to allow for easier installation of end cap 110 with a specialized tool. In some examples, end caps 108 and 110 may have various thicknesses depending upon desired appearance.

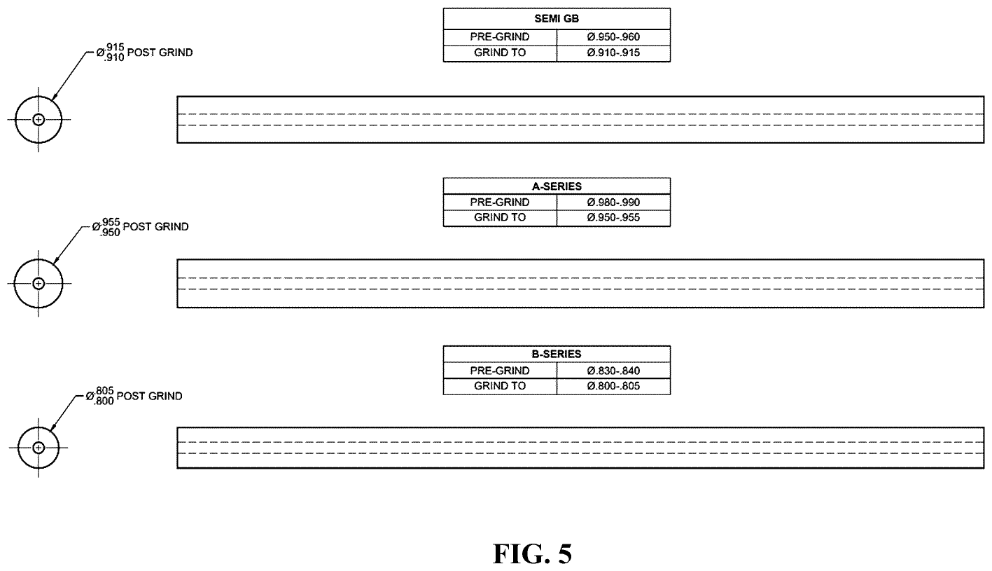

FIG. 5 depicts grinding instructions after the carbon tube 100 is cured. After a cure period, carbon tube 100 may be fed into a grinder having a feed speed of at least 12 inches per 3 minutes. In some examples, the feed blade may be made of brass to reduce vibration in the carbon tube 100 during grinding. This also reduces and/or eliminates circular striations and rings, as shown in FIG. 7A, in the finished product as shown in FIG. 6 and FIG. 7B.

The finished carbon tube 100 may be loaded into a device that traps it in such a way to prevent spinning or rotation. A resin (e.g., DP 420), or other adhesive known in the art, may be applied to the outer surface of carbon tube 100, and tube 100 may be spun or press fit onto barrel core 101, forming barrel assembly 120. The spinning ensures an even dissipation of the resin or other adhesive between the mating surfaces of carbon tube 100 and barrel core 101. A resin (e.g., DP 420), or other adhesive known in the art, may be applied to the exposed face of the carbon tube 100 on the threaded end of the barrel 102. A resin or other adhesive may also be applied to the threaded portion 102 prior to positioning end cap 108/110. End cap 108/110 may be threaded on to the barrel core 101 and torqued to at least 40 ft. lbs. to provide the tension/torsion need to increase the rigidity of the barrel assembly 120 previously discussed herein. In some examples, end cap 108/110 may be threaded on to the barrel core 101 and torqued, for example, at least, greater than, less than, equal to, or any number in between about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100 ft. lbs. Any excess resin is removed from the barrel assembly 120 and it is left to cure for at least 48 hours. In some examples, curing may include heating.

After curing, the barrel assembly 120 may be grinded/polished on a centerless grinder with a brass blade installed to create a finished product as previously discussed. When complete, the barrels may be treated with a wax to seal the barrel and prevent any penetration by moisture.

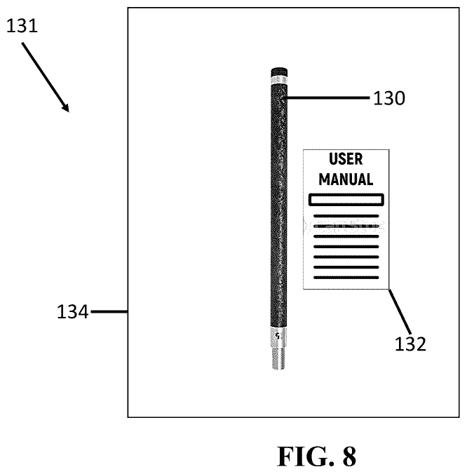

FIG. 8 depicts a firearm barrel replacement kit 131 that may include a solid-core carbon fiber barrel assembly 130 and a set of safety/installation instructions 132. In some examples, the components may be contained with a unitary packaging assembly 132.

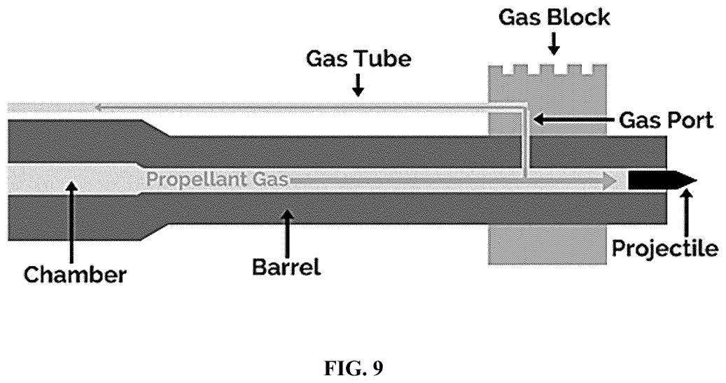

FIG. 9 depicts an AR-15 type-rifle gas block function schematic. An AR-15 type-rifle is typically a direct impingement system utilizing a gas block configured to fit over a small hole or port on the top of the rifle barrel. As gunpowder in the ammunition cartridge explodes and drives the bullet through the barrel and past this port, a portion of the hot gas escapes through it and enters the gas block and then gets directed down the gas tube. The gas tube directs the hot gas back to the rear portion of the rifle and into the receiver. The gas pressure cycles the bolt carrier group rear-ward extracting the spent cartridge and inserting a new ammunition cartridge in the chamber.

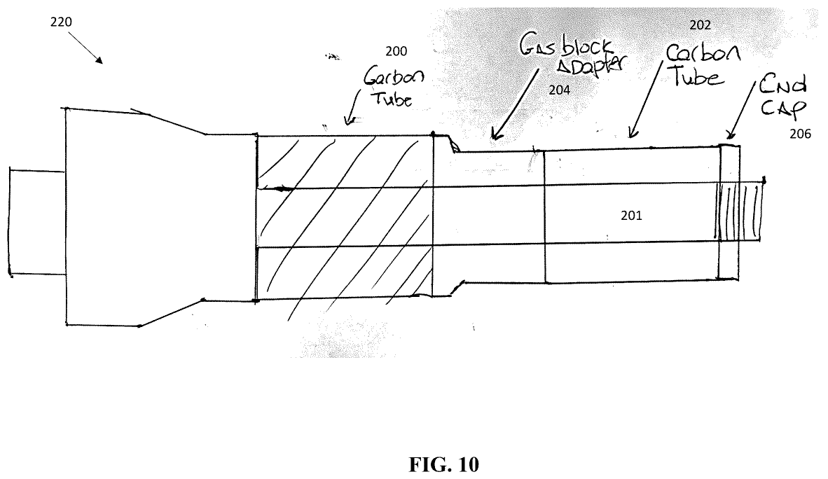

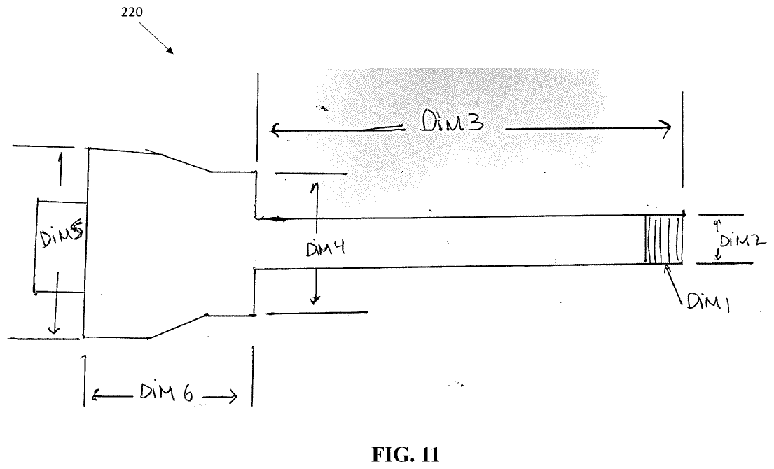

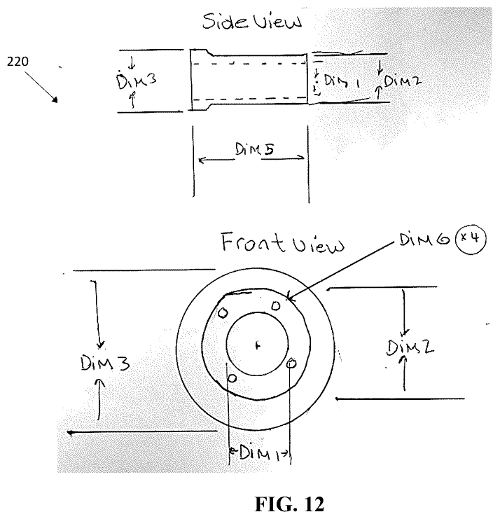

FIG. 10 depicts a side view of a gas port barrel for a rifle. Barrel core 201, carbon tubes 200 and 202, gas block adaptor 204, and end cap 206 may form gas port barrel assembly 220. Carbon tubes 200 and 202, gas block adaptor 204, and end cap 206 may be formed in accordance with the methods described above. Carbon tubes 200 and 202 may straddle or sandwich gas block adapter 204. FIG. 11 is a schematic of the gas port barrel for a firearm of FIG. 10. and FIG. 12 is an alternative schematic view of the gas port barrel for a firearm of FIG. 11. Gas block adaptor 204 may be formed any type of steel and any particular finish. In some examples, gas block adapter 204 may have holes or ports in the face to allow for easier installation of end cap 206 with a specialized tool. In other examples, gas block adapter 204 may include rings positioned around the outer diameter towards each tip and configured for the capture of gas block 204 using grub screws or other similar fastener known in the art. In yet another example, gas block adapter 204 may be torqued with any particular amount of torque to add rigidity to barrel assembly 220 resulting in improved accuracy.

The following examples are set forth as being representative of the present disclosure. These examples are not to be construed as limiting the scope of the present disclosure as these and other equivalent embodiments will be apparent in view of the present disclosure, figures and accompanying claims.

What is claimed is:

1. A method of forming a barrel for a firearm comprising the steps of:
winding a first dry prepreg carbon fiber to form a carbon tube with a first diameter, wherein the winding comprises a vertical angle from 0 to 25 degrees;
winding a second dry prepreg carbon fiber to form the carbon tube with a second diameter, wherein the winding comprises a vertical angle from 30 to 60 degrees;
bonding the carbon tube to a steel barrel core, wherein the carbon tube is bonded to the core with an epoxy or resin;
wrapping the carbon tube bonded to the steel core with a compression tape;
curing the carbon tube bonded to the steel core;
grinding the carbon tube to a third diameter; and
sealing the carbon tube bonded to the steel core.

2. The method of claim 1, wherein the carbon tube bonded to the steel core is fed into a grinder having a feed speed of at least 12 inches per 3 minutes.

3. The method of claim 2, wherein the feed blade comprises brass.

4. The method of claim 3, wherein the brass feed blade reduces vibration in the carbon tube during grinding.

5. The method of claim 1, wherein the winding of the first dry prepreg carbon fiber comprises a vertical angle from 0 to 10 degrees.

6. The method of claim 1, wherein the winding of the second dry prepreg carbon fiber comprises a vertical angle from 30 to 45 degrees.

7. The method of claim 1, wherein the first diameter is about 0.400 inches to about 2 inches.

8. The method of claim 1, wherein the second diameter is about 0.440 inches to about 3 inches.

9. The method of claim 1, wherein the third diameter is about 0.800 inches to about 3.25 inches.

10. A firearm comprising the barrel of claim 11.

11. A barrel for a firearm comprising:
a steel barrel core; and
a carbon tube bonded to an exterior of the steel barrel core, the carbon tube having a first inner diameter comprising dry prepreg carbon fibers having a wrapped vertical angle from 0 to 25 degrees, and the carbon tube having a second outer diameter comprising dry prepreg carbon fibers positioned over the first inner diameter fibers and having a wrapped vertical angle from 30 to 60 degrees.

12. The barrel of claim 11, wherein the first inner diameter is about 0.400 inches to about 2 inches.

13. The barrel of claim 11, wherein the second outer diameter is about 0.440 inches to about 3 inches.

14. The barrel of claim 11, wherein the barrel diameter is about 0.800 inches to about 3.25 inches.

15. The barrel of claim 11, wherein the first inner diameter comprises dry prepreg carbon fibers having a wrapped vertical angle from 0 to 10 degrees.

16. The barrel of claim 11, wherein the second outer diameter comprising dry prepreg carbon fibers positioned over the first inner diameter fibers comprises a wrapped vertical angle from 30 to 45 degrees.

17. The barrel of claim 11, further comprising an end cap threaded on to the barrel core and torqued to at least 40 ft. lbs.

18. A firearm comprising the barrel of claim 11.

18. A replacement barrel kit for a firearm comprising:
a carbon fiber barrel for use with a firearm comprising:
a steel barrel core; and
a carbon tube bonded to an exterior of the steel barrel core, the carbon tube having a first inner diameter comprising dry prepreg carbon fibers having a wrapped vertical angle from 0 to 25 degrees, and the carbon tube having a second outer diameter comprising dry prepreg carbon fibers positioned over the first inner diameter fibers and having a wrapped vertical angle from 30 to 60 degrees; and
a set of printed instructions,
wherein each component is combined into a unitary packaging assembly.

19. A gas port barrel for a rifle comprising:
a steel barrel core; and
a carbon tube bonded to an exterior of the steel barrel core,
wherein the rifle is an AR-15 type rifle.

20. A replacement barrel kit for a rifle comprising:
a carbon fiber gas port barrel for use with a rifle comprising:
a steel barrel core; and
a carbon tube bonded to an exterior of the steel barrel core,
wherein each component is combined into a unitary packaging assembly, and
wherein the rifle is an AR-15 type rifle.
